(19) United States
(12) Patent Application Publication
(10) Pub. No.: US 2017/0293835 A1
(43) Pub. Date: Oct. 12, 2017

(54) DATA-DRIVEN SIMULATION METHOD OF MULTIPHASE CHOKE PERFORMANCE

(71) Applicant: Saudi Arabian Oil Company, Dhahran (SA)

(72) Inventors: Mohammed D. AlAjmi, AlKhobar (SA); Sulaiman A. AlArifi, Dammam (SA)

(21) Appl. No.: 15/091,779

(22) Filed: Apr. 6, 2016

(51) Int. Cl. G06N 3/04; G06F 17/30; G06N 3/08

(52) U.S. Cl. CPC G06N 3/0427; G06N 3/084; G06F 17/30345

(57) ABSTRACT

A data base is updated that contains oil production rate test data. The oil production rate test data are collected, uploaded, and divided into subsets by a downstream-to-upstream pressure ratio. For each subset, the data is split by an oil flow rate. For each resulted subset, the data is split randomly into training data sets and testing data sets. A feed-forward back propagation neural network is built for each subset in the third step. The simulation model is calibrated utilizing actual production history from the training data set. The model performance is tested utilizing actual production history from the testing data set. If the error is within an acceptable and practicable tolerance, the resulting model is used to simulate future multiphase choke performance. Steps are repeated within a specific frequency depending on the production data flow into the data base.

### BACKGROUND

Throughout the years, artificial intelligence (AI) has been shown to outperform empirical correlations in many fields and disciplines. For example, AI can be very powerful in capturing both statistical and physical relationships between different variables. In some implementations, AI and other techniques can be used in applications associated with the oil industry.

### SUMMARY

The present disclosure describes methods and systems, including computer-implemented methods, computer program products, and computer systems, for building a data-driven choke simulation model. For example, the model can be used in the oil industry, such as to predict oil production rates through surface chokes utilizing data-driven modeling techniques.

Particular implementations of described methods and systems can include corresponding computer systems, apparatuses, or computer programs (or a combination of computer systems, apparatuses, and computer program) recorded on one or more computer storage devices, each configured to perform the actions of the methods. A system of one or more computers can be configured to perform particular operations or actions by virtue of having software, firmware, hardware, or a combination of software, firmware, or hardware installed on the system that, in operation, causes the system to perform the actions. One or more computer programs can be configured to perform particular operations or actions by virtue of including instructions that, when executed by data processing apparatus, cause the apparatus to perform the actions.

For example, in a first implementation of a computer-implemented method, the first implementation includes: updating a data base that contains oil production rate test data; collecting and uploading the oil production rate test data, and dividing the oil production rate test data into subsets by a downstream-to-upstream pressure ratio; for each subset, splitting the data into subset-splits by an oil flow rate; for each subset-splitting, split the data randomly into training data sets and testing data sets; building a feed-forward back propagation neural network; calibrating the simulation model utilizing actual production history from the training data set; testing the model performance utilizing actual production history from the testing data set; if the error is within an acceptable and practicable tolerance, proceeding with the resulting model to simulate future choke performance; and repeating the steps within a specific frequency depending on the production data flow into the data base.

The foregoing and other implementations can each optionally include one or more of the following aspects, alone or in combination:

A first aspect, combinable with the general implementation and any of the following aspects, wherein the subsets include a subset for critical flow data with a pressure ratio less than 0.5 and a subset for subcritical flow data with a pressure ratio greater than or equal to 0.5.

A second aspect, combinable with any of the previous or following aspects, wherein the subset-splits include subset-splits for each of a low range below 1200 bbl (barrels) per day, a medium range between 1200 and 2000 bbl/day, and a high range above 2000 bbl/day.

A third aspect, combinable with any of the previous or following aspects, wherein a split into training data sets and testing data sets follows a breakdown of 80% training and 20% testing.

A fourth aspect, combinable with any of the previous or following aspects, wherein feed-forward back propagation neural network includes two hidden layers.

A fifth aspect, combinable with any of the previous or following aspects, wherein the feed-forward back propagation neural network is an artificial neural network (ANN) model.

A sixth aspect, combinable with any of the previous or following aspects, wherein the ANN model includes a transformation of input variables governed by:

A=Σᵢ₌₁⁴wᵢ₁Xᵢ+b_{A} and

B=Σᵢ₌₁⁴wᵢ₂Xᵢ+b_{B},

wherein:

A and B are hidden layer variables,

wᵢⱼ is a weight from an ith input variable to a jth hidden layer variable A or B,

b_{A} is a bias of A, and

b_{B} is a bias of B,

wherein an output variable Y of the model is given by:

Y=w_{A}A+w_{B}B+b_{Y},

and wherein:

w_{A} is a weight from A to Y,

w_{B} is a weight from B to Y, and

b_{Y} is a bias of Y.

In a second implementation of a non-transitory computer-readable medium, the second implementation includes non-transitory, computer-readable medium storing one or more instructions executable by a computer system to perform operations comprising: updating a data base that contains oil production rate test data; collecting and uploading the oil production rate test data, and dividing the oil production rate test data into subsets by a downstream-to-upstream pressure ratio; for each subset, splitting the data into subset-splits by an oil flow rate; for each subset-splitting, split the data randomly into training data sets and testing data sets; building a feed-forward back propagation neural network; calibrating the simulation model utilizing actual production history from the training data set; testing the model performance utilizing actual production history from the testing data set; if the error is within an acceptable and practicable tolerance, proceeding with the resulting model to simulate future choke performance; and repeating the steps within a specific frequency depending on the production data flow into the data base.

The foregoing and other implementations can each optionally include one or more of the following features, alone or in combination:

A first aspect, combinable with the general implementation and any of the following aspects, wherein the subsets include a subset for critical flow data with a pressure ratio less than 0.5 and a subset for subcritical flow data with a pressure ratio greater than or equal to 0.5.

A second aspect, combinable with any of the previous or following aspects, wherein the subset-splits include subset-splits for each of a low range below 1200 bbl (barrels) per day, a medium range between 1200 and 2000 bbl/day, and a high range above 2000 bbl/day.

A third aspect, combinable with any of the previous or following aspects, wherein a split into training data sets and testing data sets follows a breakdown of 80% training and 20% testing.

A fourth aspect, combinable with any of the previous or following aspects, wherein feed-forward back propagation neural network includes two hidden layers.

A fifth aspect, combinable with any of the previous or following aspects, wherein the feed-forward back propagation neural network is an artificial neural network (ANN) model.

A sixth aspect, combinable with any of the previous or following aspects, wherein the ANN model includes a transformation of input variables governed by:

A=Σᵢ₌₁⁴wᵢ₁Xᵢ+b_{A} and

B=Σᵢ₌₁⁴wᵢ₂Xᵢ+b_{B},

wherein:

A and B are hidden layer variables,

wᵢⱼ is a weight from an ith input variable to a jth hidden layer variable A or B,

b_{A} is a bias of A, and

b_{B} is a bias of B,

wherein an output variable Y of the model is given by:

Y=w_{A}A+w_{B}B+b_{Y},

and wherein:

w_{A} is a weight from A to Y,

w_{B} is a weight from B to Y, and

b_{Y} is a bias of Y.

In a third implementation of a computer-implemented system, the third implementation includes a computer system, comprising: a computer memory; and a hardware processor interoperably coupled with the computer memory and configured to perform operations comprising: updating a data base that contains oil production rate test data; collecting and uploading the oil production rate test data, and dividing the oil production rate test data into subsets by a downstream-to-upstream pressure ratio; for each subset, splitting the data into subset-splits by an oil flow rate; for each subset-splitting, split the data randomly into training data sets and testing data sets; building a feed-forward back propagation neural network; calibrating the simulation model utilizing actual production history from the training data set; testing the model performance utilizing actual production history from the testing data set; if the error is within an acceptable and practicable tolerance, proceeding with the resulting model to simulate future choke performance; and repeating the steps within a specific frequency depending on the production data flow into the data base.

The foregoing and other implementations can each optionally include one or more of the following features, alone or in combination:

A first aspect, combinable with the general implementation and any of the following aspects, wherein the subsets include a subset for critical flow data with a pressure ratio less than 0.5 and a subset for subcritical flow data with a pressure ratio greater than or equal to 0.5.

A second aspect, combinable with any of the previous or following aspects, wherein the subset-splits include subset-splits for each of a low range below 1200 bbl (barrels) per day, a medium range between 1200 and 2000 bbl/day, and a high range above 2000 bbl/day.

A third aspect, combinable with any of the previous or following aspects, wherein a split into training data sets and testing data sets follows a breakdown of 80% training and 20% testing.

A fourth aspect, combinable with any of the previous or following aspects, wherein feed-forward back propagation neural network includes two hidden layers.

A fifth aspect, combinable with any of the previous or following aspects, wherein the feed-forward back propagation neural network is an artificial neural network (ANN) model.

A sixth aspect, combinable with any of the previous or following aspects, wherein the ANN model includes a transformation of input variables governed by:

A=Σᵢ₌₁⁴wᵢ₁Xᵢ+b_{A} and

B=Σᵢ₌₁⁴wᵢ₂Xᵢ+b_{B},

wherein:

A and B are hidden layer variables,

wᵢⱼ is a weight from an ith input variable to a jth hidden layer variable A or B,

b_{A} is a bias of A, and

b_{B} is a bias of B,

wherein an output variable Y of the model is given by:

Y=w_{A}A+w_{B}B+b_{Y},

and wherein:

w_{A} is a weight from A to Y,

w_{B} is a weight from B to Y, and

b_{Y} is a bias of Y.

The subject matter described in this specification can be implemented in particular implementations so as to realize one or more of the following advantages. First, virtual metering of multiphase flow in oil production wells is achieved. Second, automated validation of production rate tests' data quality is achieved. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a diagram of an example artificial neural network (ANN) model, according to an implementation.

FIG. 2 shows a diagram of an example ANN training workflow, according to an implementation.

FIG. 3 is a diagram of an example training neural network model, according to an implementation.

FIG. 4 is a block diagram of an exemplary computer system used to provide computational functionalities associated with described algorithms, methods, functions, processes, flows, and procedures as described in the instant disclosure, according to an implementation.

FIG. 5 is a flowchart of an example method for building a data-driven choke simulation model, according to an implementation.

Like reference numbers and designations in the various drawings indicate like elements.

### DETAILED DESCRIPTION

The following detailed description describes techniques associated with predicting oil production rates through surface chokes utilizing data-driven modeling techniques and is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

The following subject matter describes an automated and computer-implemented workflow to predict oil production rates through surface chokes utilizing data-driven modeling techniques. For example, the described workflow is based on an artificial intelligence (AI) tool called an artificial neural network (ANN) employed to develop oil flow rate computational AI models for both critical and subcritical multiphase through-choke flow conditions. The AI models are trained and tested on multiple production rate tests from multiple different wells from multiple oil production fields. The prediction results show an excellent match with actual field data and outperform all existing correlations in the literature to estimate oil flow rate as a function of operational conditions and choke size.

Converting data to actionable information through continuous oil production monitoring is a fundamental part of any production optimization strategy. The development of intelligent field technology has contributed remarkably to the upgrading of production surveillance frameworks and has provided an extended access to real-time data. This same technology is still in its infancy when it comes to multiphase mass metering and field practicality issues. For conventional fields, where the unavailability of continuous data flow is not considered out of norm, high uncertainty in oil production rate estimation and allocation is expected. The main source of this uncertainty is the reliance on sporadic well test data and empirical multiphase flow correlations to allocate a liquid production rate.

Critical and subcritical multiphase flow choke performance can be predicted using well-known correlations that are based on specific datasets characterized by a specific field or hydrocarbon type. Case studies where those correlations can be matched with different production data and used later to predict the choke performance are present in the literature. Yet, due to the complexity of multiphase flow behavior and variations in operational conditions, the oil industry is faced with many challenges attributed to the limited accuracy/usefulness of the documented predictions, particularly when used with field data. The described subject matter presents a computerized method to include AI data-driven models in the production surveillance system to enhance well test data validation and reduce the uncertainties in production allocation.

Wellhead choke is an integral part of any production system, as it places a flow restriction necessary to regulate production rate. Many reasons may make it desirable to restrict well production rate, including the prevention of water coning or gas cusping, protection of a reservoir and surface equipment from downstream pressure surges, sand control, reduction of high wellhead flow pressure, or sustaining economical production rate limits set by regulatory authorities.

Since an oil production rate is extremely sensitive to changes in choke size, modeling flow through chokes is vitally important for oil production simulation. In fact, having a robust choke performance model considerably contributes to the accuracy of well performance prediction as well as full system nodal analysis. Different empirical correlations based on experimental and field data have been developed to predict a liquid flow rate as a function of gas-liquid ratio (GLR), wellhead flow pressure, and choke size. However, these models fail to match a wide range of production data at different operating conditions because of (at least) the above-described challenges of the complexity of multiphase flow behavior and variations in operational conditions.

Gas-liquid flow through a choke is divided into two types: 1) critical and 2) subcritical flow based on mixture velocity and a ratio of downstream to upstream pressures (P2/P1). When a gas or mixture flow accelerates up to sonic velocity, the flow velocity becomes equal to the backpressure wave speed propagating from choke downstream to upstream. Hence, changes in downstream pressure cannot be transmitted upstream of the flow. This state is called a “critical flow” condition, where the production rate is independent of downstream pressure changes. “Subcritical flow,” on the other hand, is a state in which fluid velocity is below the sonic value and production rate is dependent on both downstream and upstream pressures. The boundary between critical and subcritical flow regimes is approximately defined by a P2/P1 value of 0.5. Whenever this ratio is less than 0.5, critical flow behavior dominates.

In the oil industry, measuring and allocating hydrocarbon rates from different wells is a complex and challenging process that involves lots of uncertainty. This uncertainty further increases when production rate test measurements are sporadic and taken from limited-accuracy measurement devices. In some cases, production rate tests are collected one time and assumed to be constant, for example, over a one-month period. This assumption is evidently invalid due to well-known variation in well performance behavior throughout the month. Such a situation necessitates allocating production rates empirically using existing choke flow correlations and continuous operating conditions data. A data-driven modeling option of multiphase choke performance was deliberately explored to provide a practical and robust alternative for existing empirical correlations.

Several researchers have scrutinized the multiphase choke performance modeling problem by studying both experimental and field data; most of them arrived at the following general empirical form for critical flow for well head pressure P_{wh}:

$${P}_{wh} = \frac{{CR}^{m} Q}{{s}^{n}} , \qquad ( 1 )$$

where, C, m, and n are empirical coefficients that are strong functions of the data being correlated. R is the Liquid-Gas Ratio in (STB/Scf), S is the choke size in (64^{th} of an inch) and Q is the liquid flow rate in (STB). It is noted that downstream pressure is excluded from equation (1), as downstream pressure has, by definition, no effect on the liquid flow rate under critical flow conditions. Table 1 shows the different correlation constants suggested by various investigators.

TABLE 1
Correlation Constants for Critical Flow Equation
Suggested by Various Investigators.

| Investigator | C | m | N |
|---|---|---|---|
| Gilbert | 10 | 0.546 | 1.84 |
| Baxendell | 9.56 | 0.546 | 1.93 |
| Ros | 17.40 | 0.500 | 2 |
| Achong | 3.82 | 0.650 | 1.88 |
| Pilehavari | 46.67 | 0.313 | 2.11 |

For the subcritical flow rate, most of the correlations used in the literature are based on pressure-volume-temperature (PVT) data and other parameters that are not comparable with the set of data used in this disclosure. In this disclosure, we have generated data-driven models for both critical and subcritical flow regimes. The correlations in Table-1 were built for the critical flow regime only, and their inputs are comparable with the inputs in the data-driven models. That is why the correlations can be used for prediction performance comparison. However, subcritical flow regime models in the literature are few and based on experimental data only. The inputs used for the subcritical flow models include PVT data and are not comparable with the current disclosure inputs where the PVT data are not used at all.

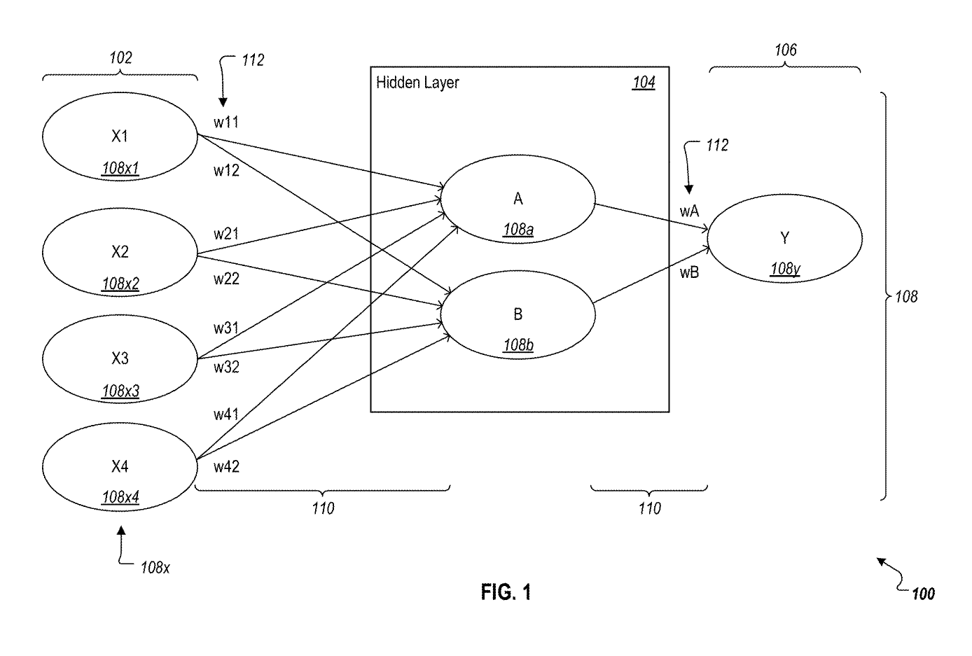

FIG. 1 is a diagram of an example ANN model 100, according to an implementation. For example, the ANN model 100 can be based on AI, which is software, hardware, or a combination of both by which a machine or software can perceive, relate, and reason with simulated/emulated human-like intelligence. An ANN model can be, for example, a computational model that can recognize complex correlations/patterns between multiple inputs and outputs. In some implementations, ANN models are inspired or modeled after one or more aspects of a human brain's behavior.

A typical scheme or function of an ANN model is to correlate four inputs with one output, though other numbers of inputs and outputs are possible. To achieve a correlation, for example, an ANN model can include a minimum of three layers. As shown in FIG. 1, the ANN model 100 includes an input layer 102, a hidden layer 104, and an output layer 106. Within the ANN model 100 are variables 108, and each of which can be called a neuron. Lines 110 connecting the neurons represent weights 112 used in the model to compute both hidden and output layers. The input layer 102 includes input variables 108x1-108x4 that make up all of the X inputs having a correlation with an output Y, which is the output variable 108y.

For the ANN model 100 to be efficient, for example, a fairly good functional dependency between outputs and inputs must exist. The functional dependency can be achieved, for example, by the hidden layer 104 that includes variables 108a and 108b and that uses mathematical transformations of the input variables X to compute output Y. Hidden layers are called “hidden” because their values are neither inputs nor outputs that can be seen by the user. Equations (2), (3) describe the mathematical relationship between the hidden layer(s) values (A and B), and the input layer values (Xᵢ). Equation (4) describes the relationship between the output (Y) and the hidden layer values (A and B). The weights (wᵢ) in equations (2), (3) and (4) are optimized to produce the most accurate output.

The transformation of input variables can be governed, for example, by the following equations:

A=Σᵢ₌₁⁴wᵢ₁Xᵢ+b_{A} (2) and

B=Σᵢ₌₁⁴wᵢ₂Xᵢ+b_{B} (3),

where, A is variable 108a, B is variable 108b, wᵢⱼ is a weight 112 from an ith input variable 108x (108x1-108x4) to a jth variable 108a or 108b, b_{A} is a bias of the variable 108a, and b_{B} is a bias of the variable 108b.

The output Y, which is the output variable 108y, can then be computed using the following equation:

Y=w_{A}A+w_{B}B+b_{Y} (4),

where, Y is the output variable 108y, w_{A} is the weight 112 from the variable 108a to the output variable 108y, w_{B} is the weight 112 from the variable 108b to the output variable 108y, and by is a bias of the output variable 108y.

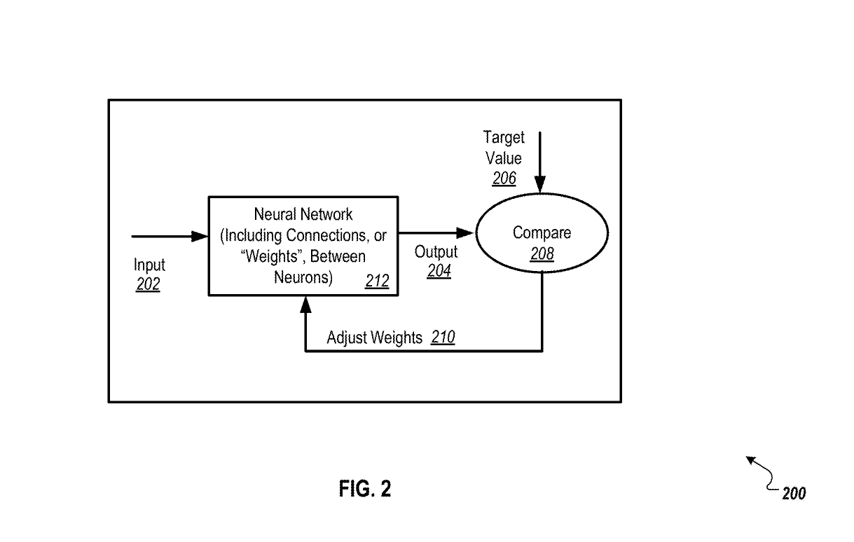

FIG. 2 shows a diagram of an example ANN training workflow 200, according to an implementation. The structure of the neural network was optimized and standardized over a large data set of more than 4500 data points. ANN models can be trained, for example, using a representative dataset of both inputs 202 and outputs 204, also referred to as targets. In some implementations, the training process can start by assigning, within a neural network 212, initial values to the weights and biases. Then, target values 206 can be predicted and compared (208) with the actual computed values to compute a difference. After calculating an error, for example based on the computed difference, weights can be adjusted 210 to further reduce the error and to achieve a better correlation between actual and simulated results. An iterative process, that is indicated by FIG. 2 for example, can minimize any resulting error. Once the network is trained, a testing dataset can be introduced to the ANN model to predict the outputs and to validate the ANN model's performance. Based on the results, weights, such as weights 112, can be iteratively adjusted to minimize the error of the output 204 compared to the target value 206. Weights can be any real number or multiplier, for example, as used in equations (2), (3) and (4).

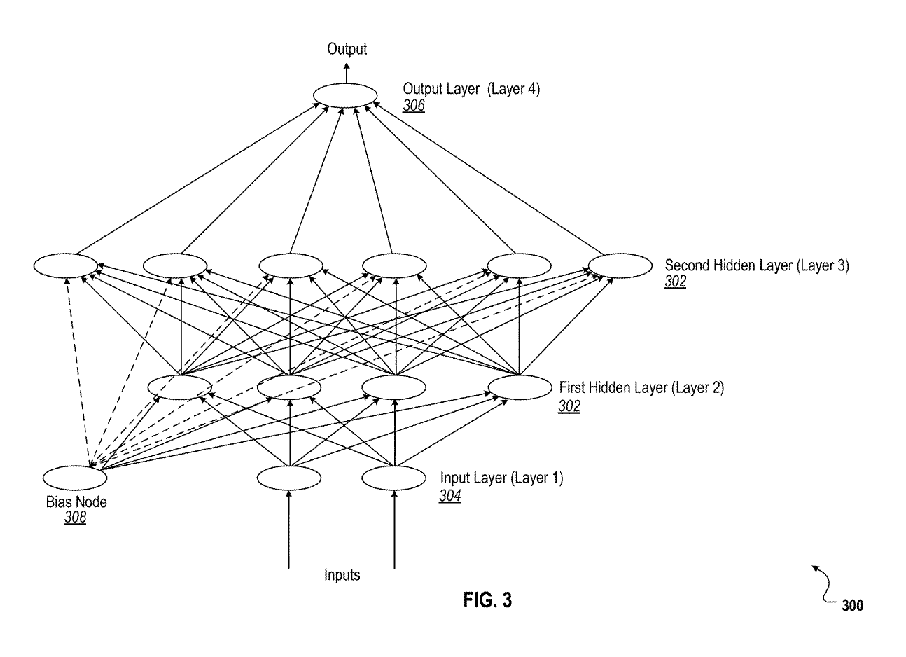

FIG. 3 is a diagram of an example training neural network model 300, according to an implementation. The training neural network model 300 includes two hidden layers 302, an input layer 304, and one output layer 306. The network structure was optimized and made specific to the choke multiphase problem. This surpassing prediction performance of this specific configuration was proven over a large data set of field rate tests. The training neural network model 300 can be used, for example, as a feed-forward back propagation type network model with two hidden layers. The training neural network model 300 also uses a bias node 308. The bias is a constant value represented by the term b in equations (2) and (3). This value is optimized along with network weights to achieve the best prediction performance.

In some implementations, to train and test a critical flow model, 80% of a total number of datasets can be used for training, and 20% of the total number of datasets can be used for testing. This ratio is part of the global optimization of the neural network. Maintaining an adequate ratio such as 20% of the overall data set of the testing data is fundamental to the overall prediction performance of the network. Testing data are the evident validation of whether a given network can consistently predict/simulate an output or not. In some implementations, training algorithms can include or use various algorithms such as a gradient descent with momentum and adaptive learning rate back propagation algorithm. In some implementations, eight (or some other number of) inputs can be used to train a model, for example, including setting an oil flow rate as a simulated prediction target of the model. Input parameters can include, for example, basic well parameters, such as the eight parameters listed below in Table 2. The transformation term

$$( \frac{{P}_{upstream} . T . S}{GLR} ) ,$$

for example, can be used as an additional input. The Gilbert correlation, defined in equation (1) and its regression constants tabulated in Table 1, can also be used as a second transformed input to improve the prediction results.

TABLE 2
Inputs and output for the critical flow ANN model.

| Input | Target |
|---|---|
| water cut % | Oil rate (bbl/d) |
| GOR (SCF/STB) = | |
| Gas-oil ratio (standard cubic feet/standard tank barrels) | |
| Temperature (F) | |
| Choke size in 1/64 of an inch | |
| Pᵤₚₛₜᵣₑₐₘ (psig) | |
| GLR (SCF/STB) | |
| $\frac{{P}_{upstream} \cdot T \cdot S}{GLR}$ | |
| Gilbert correlation | |

In some implementations, to train and test a subcritical flow model, 80% of a total number of datasets can be used for training, and 20% of the total number of datasets can be used for testing. In some implementations, a Levenberg-Marquardt back-propagation algorithm. The Levenberg-Marquardt algorithm provides a numerical solution to the problem of minimizing a nonlinear function. The algorithm is fast and has stable convergence. This method is used to iteratively update the weights and biases of a given network using the generated prediction errors. Weights and biases updating can continue until the minimum error is achieved. For example, nine inputs can be used for the model, including setting an oil flow rate as the simulated prediction target. In some implementations, input parameters for the model can include basic well parameters, such as the parameters listed in Table 3. In some implementations, five transformations, or iterations, of the input data can be used to improve the network prediction performance. The number of inputs chosen can be shown to be optimum. The optimization was achieved after extensive experimentation and more than 300 simulation runs. Inputs, layers, and number of neurons are fixed and specific to the subject invention problem.

TABLE 3
Inputs and output for the subcritical flow ANN model.

| Input | Target |
|---|---|
| water cut % | Oil rate (bpd) |
| Pᵤₚₛₜᵣₑₐₘ psig | |
| P_{downstream}/Pᵤₚₛₜᵣₑₐₘ | |
| GLR (SCF/STB) | |
| Log (S) | |
| GOR.WC (water cut %) | |
| Δp/Pᵤₚₛₜᵣₑₐₘ | |
| Temperature/Pᵤₚₛₜᵣₑₐₘ | |
| 1/log(choke size) | |

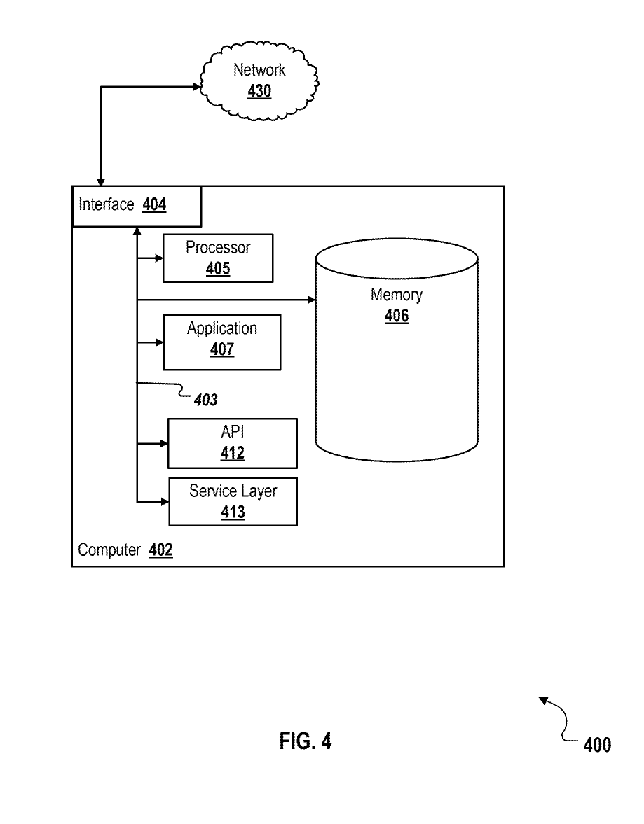

FIG. 4 is a block diagram of an exemplary computer system 400 used to provide computational functionalities associated with described algorithms, methods, functions, processes, flows, and procedures as described in the instant disclosure, according to an implementation. The illustrated computer 402 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 402 may comprise a computer that includes an input device, such as a keypad, keyboard, touch screen, or other device that can accept user information, and an output device that conveys information associated with the operation of the computer 402, including digital data, visual, or audio information (or a combination of information), or a GUI.

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, business intelligence (BI) server, or other server (or a combination of servers).

The computer 402 can receive requests over network 430 from a client application (for example, executing on another computer 402) and responding to the received requests by processing the said requests in an appropriate software application. In addition, requests may also be sent to the computer 402 from internal users (for example, from a command console or by other appropriate access method), external or third-parties, other automated applications, as well as any other appropriate entities, individuals, systems, or computers.

Each of the components of the computer 402 can communicate using a system bus 403. In some implementations, any or all of the components of the computer 402, both hardware or software (or a combination of hardware and software), may interface with each other or the interface 404 (or a combination of both) over the system bus 403 using an application programming interface (API) 412 or a service layer 413 (or a combination of the API 412 and service layer 413). The API 412 may include specifications for routines, data structures, and object classes. The API 412 may be either computer-language independent or dependent and refer to a complete interface, a single function, or even a set of APIs. The service layer 413 provides software services to the computer 402 or other components (whether or not illustrated) that are communicably coupled to the computer 402. The functionality of the computer 402 may be accessible for all service consumers using this service layer. Software services, such as those provided by the service layer 413, provide reusable, defined business functionalities through a defined interface. For example, the interface may be software written in JAVA, C++, or other suitable language providing data in extensible markup language (XML) format or other suitable format. While illustrated as an integrated component of the computer 402, alternative implementations may illustrate the API 412 or the service layer 413 as stand-alone components in relation to other components of the computer 402 or other components (whether or not illustrated) that are communicably coupled to the computer 402. Moreover, any or all parts of the API 412 or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402. The interface 404 is used by the computer 402 for communicating with other systems in a distributed environment that are connected to the network 430 (whether illustrated or not). Generally, the interface 404 comprises logic encoded in software or hardware (or a combination of software and hardware) and operable to communicate with the network 430. More specifically, the interface 404 may comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors may be used according to particular needs, desires, or particular implementations of the computer 402. Generally, the processor 405 executes instructions and manipulates data to perform the operations of the computer 402 and any algorithms, methods, functions, processes, flows, and procedures as described in the instant disclosure.

The computer 402 also includes a memory 406 that holds data for the computer 402 or other components (or a combination of both) that can be connected to the network 430 (whether illustrated or not). For example, memory 406 can be a database storing data consistent with this disclosure. Although illustrated as a single memory 406 in FIG. 4, two or more memories may be used according to particular needs, desires, or particular implementations of the computer 402 and the described functionality. While memory 406 is illustrated as an integral component of the computer 402, in alternative implementations, memory 406 can be external to the computer 402.

The application 407 is an algorithmic software engine providing functionality according to particular needs, desires, or particular implementations of the computer 402, particularly with respect to functionality described in this disclosure. For example, application 407 can serve as one or more components, modules, applications, etc. Further, although illustrated as a single application 407, the application 407 may be implemented as multiple applications 407 on the computer 402. In addition, although illustrated as integral to the computer 402, in alternative implementations, the application 407 can be external to the computer 402.

There may be any number of computers 402 associated with, or external to, a computer system containing computer 402, each computer 402 communicating over network 430. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

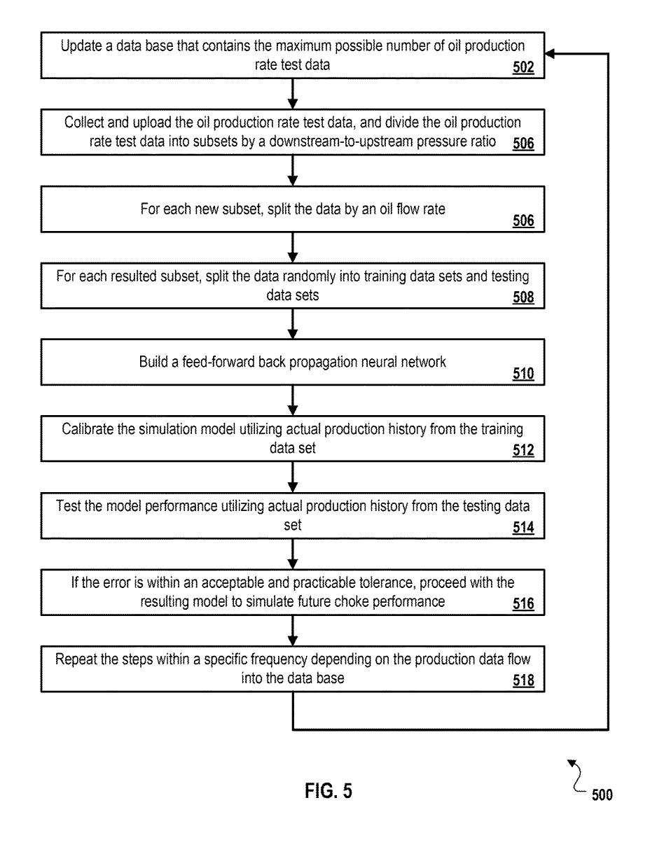

FIG. 5 is a flowchart of an example method 500 for building a data-driven choke simulation model, according to an implementation. For example, building a data-driven choke simulation model requires having a significantly large data base that is updated dynamically with production rate test data. A typical data base can include basic input parameters, for example, using parameters as described above, above such as upstream pressure, a downstream pressure, water cut, gas/oil ratio (GOR), and choke size. In some implementations, a minimum number of data points required for building a robust and representative model can be 1000 (or some other value). However, a lesser number can produce practical results, such as using as few as 100 data points. In some implementations, a detailed workflow to generate a choke performance model for a specific field can follow the following steps. For clarity of presentation, the description that follows generally describes method 500 in the context of the other figures in this description. However, it will be understood that method 500 may be performed, for example, by any suitable system, environment, software, and hardware, or a combination of systems, environments, software, and hardware as appropriate. In some implementations, various steps of method 500 can be run in parallel, in combination, in loops, or in any order.

At 502, a data base is updated that contains oil production rate test data. The updates can occur continuously over time, for example, as more tests are conducted and to acquire a maximum possible number of data points. From 502, method 500 proceeds to 504.

At 504, the oil production rate test data are collected, uploaded, and divided into subsets by a downstream-to-upstream pressure ratio. For example, division into subsets can be as follows: a subset for critical flow data with a pressure ratio less than 0.5, and a subset for subcritical flow data with a pressure ratio greater than or equal to 0.5. The data can be stored, for example, in persistent storage, such as in one or more data bases. From 504, method 500 proceeds to 506.

At 506, for each subset, the data is split into subset-splits by an oil flow rate. The split can occur, for example, in three splits as follows: a low range below 1200 bbl (barrels) per day, a medium range between 1200 and 2000 bbl/day, and a high range above 2000 bbl/day. This classification can be field- or area-specific and can mainly depend on ANN model error analysis as a function of an actual flow rate to be predicted. For instance, the error can be found to be increasing sharply whenever the actual rate falls below 1200 bbl/day in all the fields under study. From 506, method 500 proceeds to 508.

At 508, for each subset-split, the data is split randomly into training data sets and testing data sets. For example, training data can be used to calibrate and match the ANN model while testing data can be used to blind-test and verify the model performance. In some implementations, the recommended breakdown can be 80% training and 20% testing. In some implementations, these cutoffs can be determined, for example, after conducting numerous runs with multiple ANN models and computational algorithms. From 508, method 500 proceeds to 510.

At 510, a feed-forward back propagation neural network is built for each subset in the third step. For example, the training neural network model 300 can be built using the data sets. In some implementations, the feed-forward back propagation neural network includes two hidden layers. From 510, method 500 proceeds to 512.

At 512, the simulation model is calibrated utilizing actual production history from the training data set. For example, using a process similar to that described with respect to FIG. 2, the simulation model can be calibrated. From 512, method 500 proceeds to 514.

At 514, the model performance is tested utilizing actual production history from the testing data set. For example, actual oil flow rates can be used to train the model. From 514, method 500 proceeds to 516.

At 516, if the error is within an acceptable and practicable tolerance, the resulting model is used to simulate future choke performance. For example, as error rates are determined to converge to a rate indicating that the model has achieved its purpose, the model can be used in production applications. From 516, method 500 proceeds to 518.

At 518, steps 502 through 516 are repeated within a specific frequency depending on the production data flow into the data base. From 518, method 500 stops.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an application programming interface (API) or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
updating a data base that contains oil production rate test data;
collecting and uploading the oil production rate test data, and dividing the oil production rate test data into subsets by a downstream-to-upstream pressure ratio;
for each subset, splitting the data into subset-splits by an oil flow rate;
for each subset-split, splitting the data randomly into training data sets and testing data sets;
building a feed-forward back propagation neural network;
calibrating the simulation model utilizing actual production history from the training data set;
testing the model performance utilizing actual production history from the testing data set;
if the error is within an acceptable and practicable tolerance, proceeding with the resulting model to simulate future choke performance; and
repeating the steps within a specific frequency depending on the production data flow into the data base.

2. The computer-implemented method of claim 1, wherein the subsets include a subset for critical flow data with a pressure ratio less than 0.5 and a subset for subcritical flow data with a pressure ratio greater than or equal to 0.5.

3. The computer-implemented method of claim 1, wherein the subset-splits include subset-splits for each of a low range below 1200 bbl (barrels) per day, a medium range between 1200 and 2000 bbl/day, and a high range above 2000 bbl/day.

4. The computer-implemented method of claim 1, wherein a split into training data sets and testing data sets follows a breakdown of 80% training and 20% testing.

5. The method of claim 1, wherein feed-forward back propagation neural network includes two hidden layers.

6. The computer-implemented method of claim 1, wherein the feed-forward back propagation neural network is an artificial neural network (ANN) model.

7. The computer-implemented method of claim 6, wherein the ANN model includes a transformation of input variables governed by:
A=Σᵢ₌₁⁴wᵢ₁Xᵢ+b_{A} and
B=Σᵢ₌₁⁴wᵢ₂Xᵢ+b_{B},
wherein:
A and B are hidden layer variables,
wᵢⱼ is a weight from an ith input variable to a jth hidden layer variable A or B,
b_{A} is a bias of A, and
b_{B} is a bias of B,
wherein an output variable Y of the model is given by:
Y=w_{A}A+w_{B}B+b_{Y},
and wherein:
w_{A} is a weight from A to Y,
w_{B} is a weight from B to Y, and
b_{Y} is a bias of Y.

8. A non-transitory, computer-readable medium storing one or more instructions executable by a computer system to perform operations comprising:
updating a data base that contains oil production rate test data;
collecting and uploading the oil production rate test data, and dividing the oil production rate test data into subsets by a downstream-to-upstream pressure ratio;
for each subset, splitting the data into subset-splits by an oil flow rate;
for each subset-split, splitting the data randomly into training data sets and testing data sets;
building a feed-forward back propagation neural network;
calibrating the simulation model utilizing actual production history from the training data set;
testing the model performance utilizing actual production history from the testing data set;
if the error is within an acceptable and practicable tolerance, proceeding with the resulting model to simulate future choke performance; and
repeating the steps within a specific frequency depending on the production data flow into the data base.

9. The non-transitory, computer-readable medium of claim 8, wherein the subsets include a subset for critical flow data with a pressure ratio less than 0.5 and a subset for subcritical flow data with a pressure ratio greater than or equal to 0.5.

10. The non-transitory, computer-readable medium of claim 8, wherein the subset-splits include subset-splits for each of a low range below 1200 bbl (barrels) per day, a medium range between 1200 and 2000 bbl/day, and a high range above 2000 bbl/day.

11. The non-transitory, computer-readable medium of claim 8, wherein a split into training data sets and testing data sets follows a breakdown of 80% training and 20% testing.

12. The non-transitory, computer-readable medium of claim 8, wherein feed-forward back propagation neural network includes two hidden layers.

13. The non-transitory, computer-readable medium of claim 8, wherein the feed-forward back propagation neural network is an artificial neural network (ANN) model.

14. The non-transitory, computer-readable medium of claim 13, wherein the ANN model includes a transformation of input variables governed by:
A=Σᵢ₌₁⁴wᵢ₁Xᵢ+b_{A} and
B=Σᵢ₌₁⁴wᵢ₂Xᵢ+b_{B},
wherein:
A and B are hidden layer variables,
wᵢⱼ is a weight from an ith input variable to a jth hidden layer variable A or B,
b_{A} is a bias of A, and
b_{B} is a bias of B,
wherein an output variable Y of the model is given by:
Y=w_{A}A+w_{B}B+b_{Y},
and wherein:
w_{A} is a weight from A to Y,
w_{B} is a weight from B to Y, and
b_{Y} is a bias of Y.

15. A computer system, comprising:
a computer memory; and
a hardware processor interoperably coupled with the computer memory and configured to perform operations comprising:
updating a data base that contains oil production rate test data;
collecting and uploading the oil production rate test data, and dividing the oil production rate test data into subsets by a downstream-to-upstream pressure ratio;
for each subset, splitting the data into subset-splits by an oil flow rate;
for each subset-split, splitting the data randomly into training data sets and testing data sets;
building a feed-forward back propagation neural network;
calibrating the simulation model utilizing actual production history from the training data set;
testing the model performance utilizing actual production history from the testing data set;
if the error is within an acceptable and practicable tolerance, proceeding with the resulting model to simulate future choke performance; and
repeating the steps within a specific frequency depending on the production data flow into the data base.

16. The computer system of claim 15, wherein the subsets include a subset for critical flow data with a pressure ratio less than 0.5 and a subset for subcritical flow data with a pressure ratio greater than or equal to 0.5.

17. The computer system of claim 15, wherein the subset-splits include subset-splits for each of a low range below 1200 bbl (barrels) per day, a medium range between 1200 and 2000 bbl/day, and a high range above 2000 bbl/day.

18. The computer system of claim 15, wherein a split into training data sets and testing data sets follows a breakdown of 80% training and 20% testing.

19. The computer system of claim 15, wherein the feed-forward back propagation neural network is an artificial neural network (ANN) model.

20. The computer system of claim 20, wherein the ANN model includes a transformation of input variables governed by:
A=Σᵢ₌₁⁴wᵢ₁Xᵢ+b_{A} and
B=Σᵢ₌₁⁴wᵢ₂Xᵢ+b_{B},
wherein:
A and B are hidden layer variables,
wᵢⱼ is a weight from an ith input variable to a jth hidden layer variable A or B,
b_{A} is a bias of A, and
b_{B} is a bias of B,
wherein an output variable Y of the model is given by:
Y=w_{A}A+w_{B}B+b_{Y},
and wherein:
w_{A} is a weight from A to Y,
w_{B} is a weight from B to Y, and
b_{Y} is a bias of Y.
